(19) United States
(12) Patent Application Publication
(10) Pub. No.: US 2021/0046986 A1
(43) Pub. Date: Feb. 18, 2021

(54) CONNECTORS FOR TRAILER WALLS AND METHOD OF INSTALLATION THEREOF

(71) Applicant: IDEAL CARGO INC., Saint-Valere (CA)

(72) Inventors: Stanley Labrecque, Trois-Rivieres (CA); Mehdi Guerroumi, Trois-Rivieres (CA); Vincent Desilets, Sainte-Eulalie (CA)

(21) Appl. No.: 16/994,534

(22) Filed: Aug. 14, 2020

Related U.S. Application Data
(60) Provisional application No. 62/886,413, filed on Aug. 14, 2019.

(51) Int. Cl. B62D 63/08; B62D 33/04

(52) U.S. Cl. CPC B62D 63/08; B62D 33/046

(57) ABSTRACT

A connector configured to secure laminate walls of a vehicle trailer, the connector comprising a first cavity and a second cavity disposed with about 90-degree with the first cavity, each cavity comprising a pair of lateral walls and a bottom wall. The connector may further comprise an inclined portion with a slot located between a lateral wall of each cavities, the inclined portion creating another cavity wherein miscellaneous objects such as wires or hooks may be installed. A cover portion may be installed over the inclined portion to cover the slot for visual and practical effects. One cavity may be configured to receive a frame component, said frame component generally having bigger dimensions.

### CROSS-REFERENCE TO RELATED APPLICATIONS

The present patent application claims the benefits of priority of U.S. Provisional Patent Application No. 62/886,413, entitled “CONNECTORS FOR TRAILER WALLS AND METHOD OF INSTALLATION THEREOF”, and filed at the United States Patent and Trademark Office on Aug. 14, 2020, the content of which is incorporated herein by reference.

### FIELD OF THE INVENTION

The present invention generally relates to the field of securing members for trailer walls. Specifically, the present invention relates to a securing member configured to secure composites trailer walls together without reducing the mechanical strength of the composite walls.

### BACKGROUND OF THE INVENTION

Trailers are pulled by vehicles and they can significantly increase the fuel consumption of the vehicle by their weight and their aerodynamic drag. The weight and the shape of the trailer is hence of significant importance. Using composite panels in a trailer construction is helping to limit or to reduce the weight of the trailer. Composite panels are generally using a composite sandwich construction and they should be assembled in a fashion adapted to properly secure the composite panels while ensuring their mechanical integrity.

It is therefore desirable to find a way to join composite panels in a trailer construction that is going to sustain the mechanical loads and sustain vibrations that are going to be applied to the trailer.

### OBJECTS OF THE INVENTION

An object of the present invention, in accordance with at least one embodiment thereof, is providing a composite panel junction member that is light and provide significant mechanical strength.

One other object of the present invention, in accordance with at least one embodiment thereof, is providing a composite panel junction member that is light and is resistant to corrosion.

One object of the present invention, in accordance with at least one embodiment thereof, is providing a composite panel junction member that is engaging and securing two composite panels together while maintaining the mechanical integrity of the composite panels.

One object of the present invention, in accordance with at least one embodiment thereof, is providing a composite panel junction member that is inexpensive to manufacture and easy to assemble.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

The present invention includes many aspects and features. The aforesaid and other objectives of the present invention are realized by generally providing a new watercraft boarding apparatus and method of use thereof.

One aspect of the invention provides, in accordance with at least one embodiment thereof, a composite panel junction member configured to assemble and secure two composite panels together.

One aspect of the invention provides, in accordance with at least one embodiment thereof, a composite panel junction member configured to receive and capture therein the entire thickness of two composite panels.

One aspect of the invention provides, in accordance with at least one embodiment thereof, a composite panel junction member including one or more ridges to increase its mechanical strength.

One aspect of the invention provides, in accordance with at least one embodiment thereof, a composite panel junction member including series of engaging teeth for increased mechanical engagement with the two composite panels.

One aspect of the invention provides, in accordance with at least one embodiment thereof, a composite panel junction member configured to receive therein electrical wires.

One aspect of the invention provides, in accordance with at least one embodiment thereof, a composite panel junction member configured to secure thereon electric lights.

In a further aspect of the invention, a connector for securing at least two panels of a trailer at an angle, the connector comprising a main wall and a first lateral wall, a second lateral wall and a third lateral wall disposed at the angle in relation to the first and second lateral walls, a first cavity formed by a section of the main wall, the first lateral wall and a section of the second lateral wall and a second cavity formed by the third lateral wall, a section of the second lateral wall and a section of the main wall, each cavity being configured to receive a portion of a panel.

The main wall may comprise a plurality of ridges. The at least one of the main, first lateral, second lateral or third lateral wall may a friction surface. The friction surfaces of parallel walls may face one another. The friction surface may comprise engaging teeth.

An outer surface of the main wall may comprise cavity ridges. The first lateral wall and the second lateral wall may form a third cavity. The third cavity may be further formed by an inclined wall connected to the first and the second lateral walls. The third cavity may be adapted to receive cables. The inclined wall may comprise an opening. The connector may further comprise a detachable cover to close the opening.

Each cavity may have a width of 1 inch. Each cavity may have a width of 1/16 inch over the thickness of the panels to be received by each cavity.

In another aspect of the invention, a connector for securing at least two panels is provided. The connector comprises a main wall and a first lateral wall, a second lateral wall and a third lateral wall disposed at an angle in relation to the main and first lateral walls, a first cavity formed by a section of the main wall, a section of the first lateral wall and of the second lateral wall, a second cavity formed by the third lateral wall, a section of the second lateral wall and a section of the main wall, each cavity being configured to receive a portion of a panel and cavity ridges located on the surface of the walls comprised in the first and second cavities, wherein the main wall comprises a plurality of ridges, at least one of the main, first lateral, second lateral or third lateral wall comprises a friction surface, the friction surfaces of two parallel walls face each other's and the friction surfaces comprise engaging teeth.

The connector may further comprise a third cavity formed by the first and the second lateral walls, an inclined wall connected to the first and the second lateral walls further forming the third cavity, an opening located on the inclined wall and a detachable cover to close the opening.

In another aspect of the invention, a method for connecting panels of a trailer at an angle. The method comprises inserting a first panel into a first rigid cavity, inserting a second panel into a second rigid cavity, the second rigid cavity being at an angle of the first rigid cavity, securing the first panel to the first cavity, securing the second panel to the second cavity.

The method may further comprise frictionally holding the first and second panels in the first and second cavities respectively.

The method may further comprise inserting cables in a third cavity connected to the first and second cavities.

The features of the present invention which are believed to be novel are set forth with particularity in the appended claims. Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is a perspective isometric view of a trailer in accordance with the principles of the present invention;

FIG. 2 is a perspective isometric view of a first junction member engaged with two composite panels in accordance with the principles of the present invention;

FIG. 3 is a perspective isometric view of the first junction member in accordance with the principles of the present invention;

FIG. 4 is a front view of the first junction member in accordance with the principles of the present invention;

FIG. 5 is a left elevation view of the first junction member in accordance with the principles of the present invention;

FIG. 6 is a right elevation view of the first junction member in accordance with the principles of the present invention;

FIG. 7 is a perspective isometric view of a second junction member engaged with two composite panels in accordance with the principles of the present invention;

FIG. 8 is a perspective isometric view of the second junction member in accordance with the principles of the present invention;

FIG. 9 is a front view of the second junction member in accordance with the principles of the present invention;

FIG. 10 is a left elevation view of the second junction member in accordance with the principles of the present invention;

FIG. 11 is a right elevation view of the second junction member in accordance with the principles of the present invention;

FIG. 12 is a perspective isometric view of a third junction member engaged with two composite panels in accordance with the principles of the present invention;

FIG. 13 is a perspective isometric view of the third junction member in accordance with the principles of the present invention;

FIG. 14 is a front view of the third junction member in accordance with the principles of the present invention;

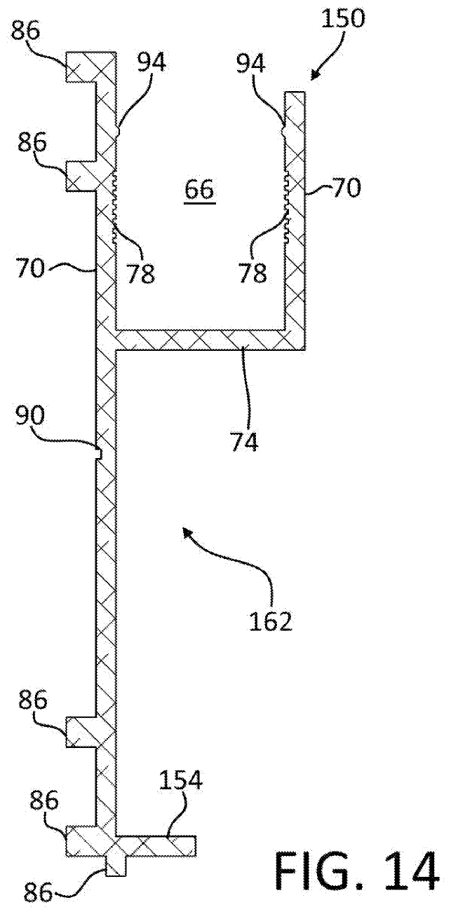

FIG. 15 is a left elevation view of the third junction member in accordance with the principles of the present invention; and

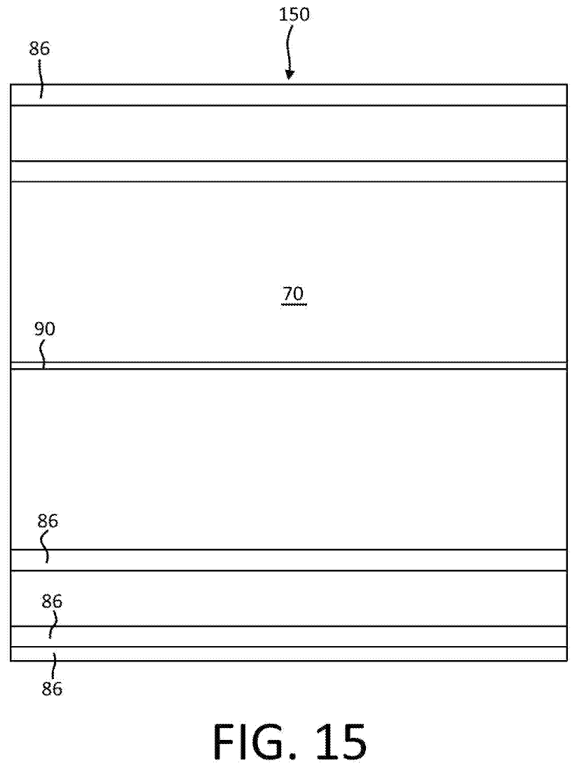

FIG. 16 is a right elevation view of the third junction member in accordance with the principles of the present invention.

FIG. 17 is a front view of an embodiment of a connector for trailer walls in accordance with the principles of the present invention, the connector having two cavities at an angle.

FIG. 18 is a front view of an embodiment of a connector for trailer walls in accordance with the principles of the present invention, the connector having two cavities at an angle.

FIG. 19 is a front view of an embodiment of a connector for trailer walls in accordance with the principles of the present invention, the connector comprising a groove in the bottom portion of the cavities.

FIG. 20 is a front view of an embodiment of a connector for trailer walls having a third cavity in accordance with the principles of the present invention, the connector comprising a groove in the bottom portion of the cavities.

FIG. 21 is a front view of an embodiment of a connector for trailer walls in accordance with the principles of the present invention, the connector comprising a groove on the outer portions of the connector.

FIG. 22 is a front view of another embodiment of a connector for trailer walls having four cavities in accordance with the principles of the present invention.

FIG. 23 is a front view of a further embodiment of a connector for trailer walls having two side cavities and a central cavity in accordance with the principles of the present invention.

FIG. 24 is a front view of a further embodiment of a connector for trailer walls having a central cavity and clipping members in accordance with the principles of the present invention.

FIG. 25 is a front view of a further embodiment of a connector for trailer walls having a L-shape in accordance with the principles of the present invention.

FIG. 26 is a front view of another embodiment of a connector for trailer walls having a main cavity and a flat portion in accordance with the principles of the present invention.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein; or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention is to be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once during performance of the claimed method.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” When used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring the drawings, one or more preferred embodiments of the invention are next described. The following description of one or more preferred embodiments is merely exemplary in nature and is in no way intended to limit the invention, its implementations, or uses. Hence, a novel resistance apparatus will be described herein after.

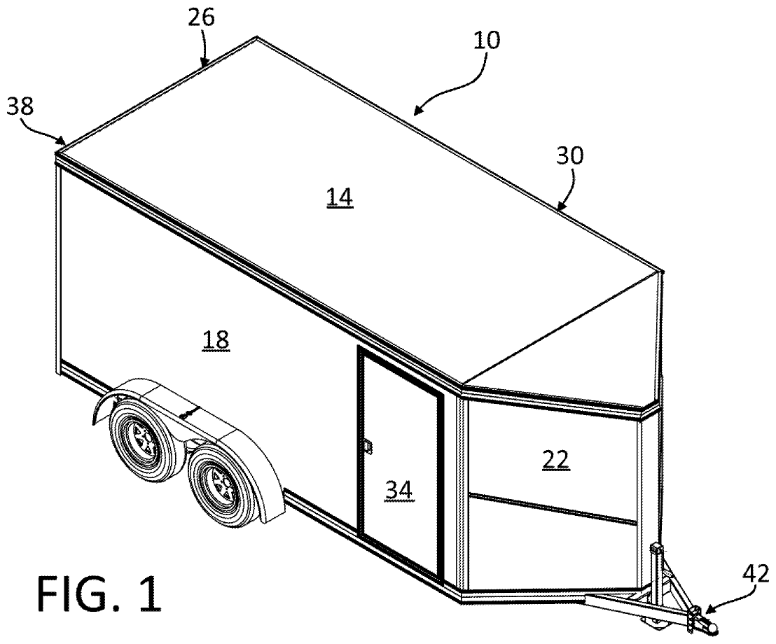

An embodiment of a trailer 10 is illustrated in FIG. 1. The trailer 10 generally comprises a roof portion 14, a right-side portion 18, a front portion 22, a rear portion 26, a left side portion 30. The trailer 10 may further comprise a floor portion (not shown). The exemplary trailer 10 also includes a lateral door 34 and a rear door 38. A connector member 42 is shown in front of the trailer 10 to connect said trailer 10 to a hauling vehicle (not illustrated). The different portions of the trailer 10 may comprise at least one or more composite panels 54 to embody the shape of the trailer 10, secure the cargo in the trailer 10 and provide mechanical strength to the trailer 10. The composite panels 54 may be secured to other composite panels or other parts and portions of the trailer 10 by the use of connectors (50, 100 and 150) with various embodiments of said panels 54 described below. Understandably, the trailer 10 may be embodied as any known types of trailers, such as but not limited to closed, semi-open or open trailer having side walls.

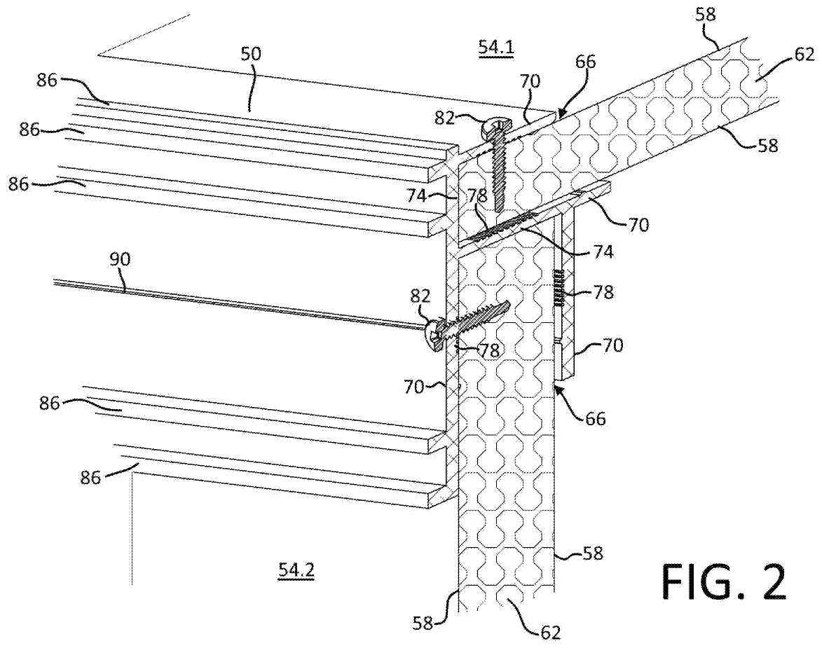

Referring now to FIG. 2, an embodiment of a first connector 50 is illustrated. The connector 50 generally joins two composite panels 54.1 and 54.2. Each of the composite panels 54.1, 54.2 is engaged in a panel-receiving cavity 66 sized and designed to allow insertion of the panels 54.1, 54.2 therein while ensuring a proper fit to prevent any relative movements between the parts. Each of the composite panels 54.1, 54.2 includes external wall portions 58 assembled to a core portion 62 in between to give significant mechanical strength while being rather light and inexpensive. The pair of panels-receiving cavities 66 are about 90-degree angle thereof in the illustrated embodiment although other angles are contemplated by the present invention. One can appreciate that each panel receiving cavity 66 includes a pair of lateral walls 70 and a bottom wall 74.

The lateral walls 70 may further comprise series of optional engaging teeth 78 are to further engage the composite panel 54 exterior surface and/or to further increase the mechanical connection and/or friction between the components. Understandably, any other means or mechanism increasing the mechanical connection and/or friction between the components may be used. Fasteners 82, in the present situation embodied as screws, are inserted through the connector 50 lateral walls 70 to engage the composite panel 54 inserted in the panel receiving cavity 66. The fasteners 82 are axially aligned toward the series of engaging teeth 78 for further connection strength. A plurality of ridges 86 are provided on the exterior surface of the first connector 50 for added mechanical strength while an axial groove 90 is provided to guide the fasteners 82 locations on the first connector 50. A plurality of cavity ridges 94 are provided on the lateral walls 70 surfaces inside the first and second cavities 66 to help secure and assure a tighter fit of the received panels 54.1, 54.2.

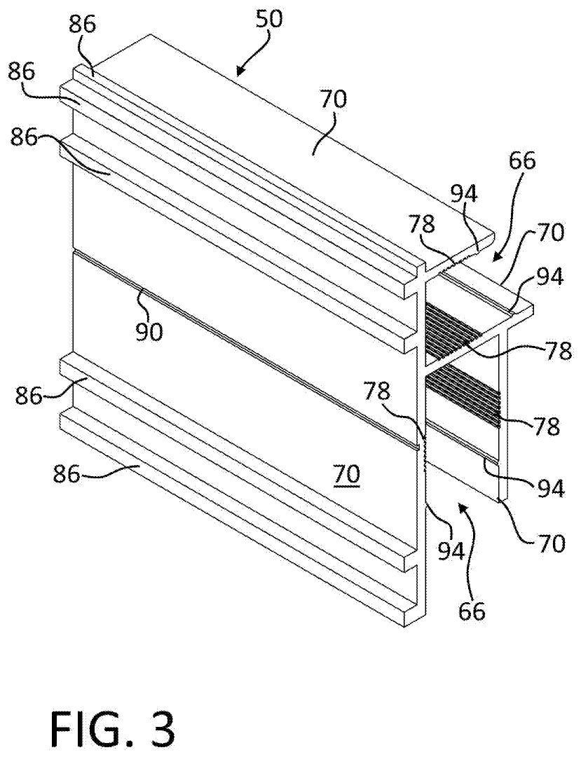

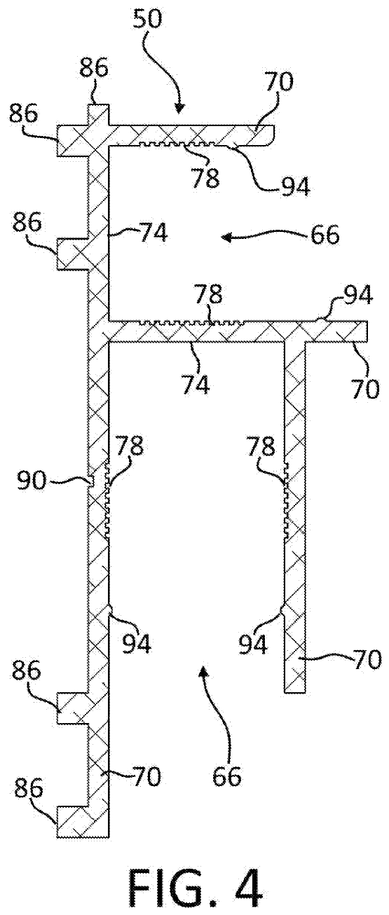

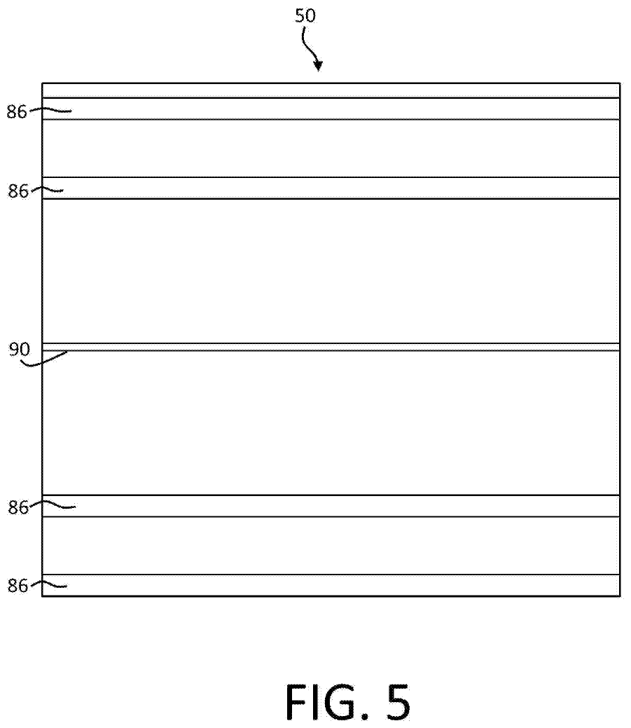

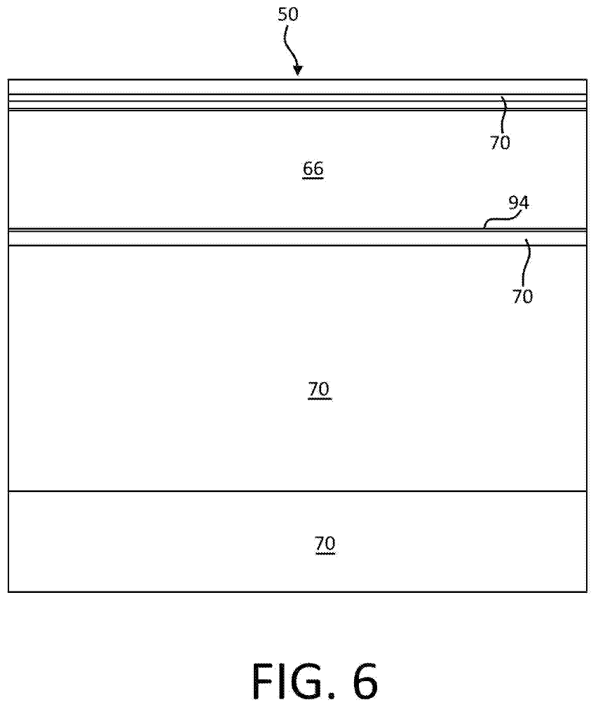

Referring now to FIGS. 3 to 6 the first connector 50 is illustrated through various other alternative views for a better understanding of its design and features.

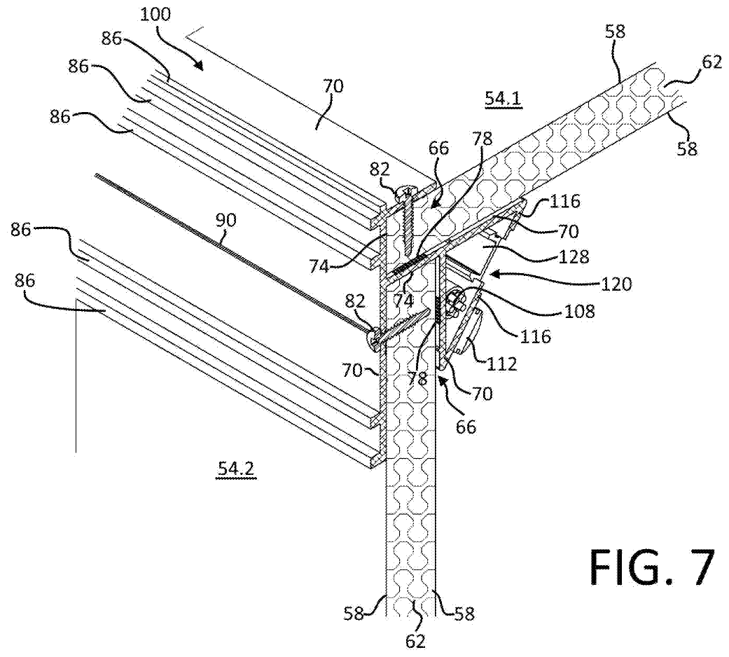

Referring to FIG. 7, an embodiment of a second connector 100 is illustrated. The second connector 100 generally interconnects two composite panels 54.1 and 54.2. Each of the composite panels 54.1, 54.2 is engaged in a panel receiving cavity 66 sized and designed to allow insertion of the panels 54.1 and 54.2 therein while ensuring a proper fit to prevent any relative movements between the parts. Each of the composite panels 54.1, 54.2 includes external wall portions 58 assembled to a core portion 62 in between to give significant mechanical strength while being rather light and inexpensive. The pair of panels receiving cavities 66 are about 90-degree angle thereof in the illustrated embodiment although other angles are contemplated by the present invention. One can appreciate that each panel-receiving cavity 66 includes a pair of lateral walls 70 and a bottom wall 74.

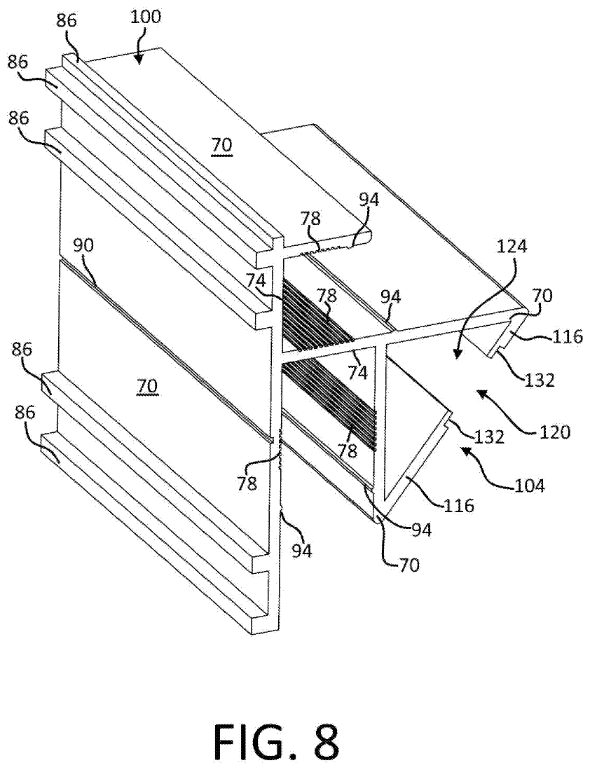

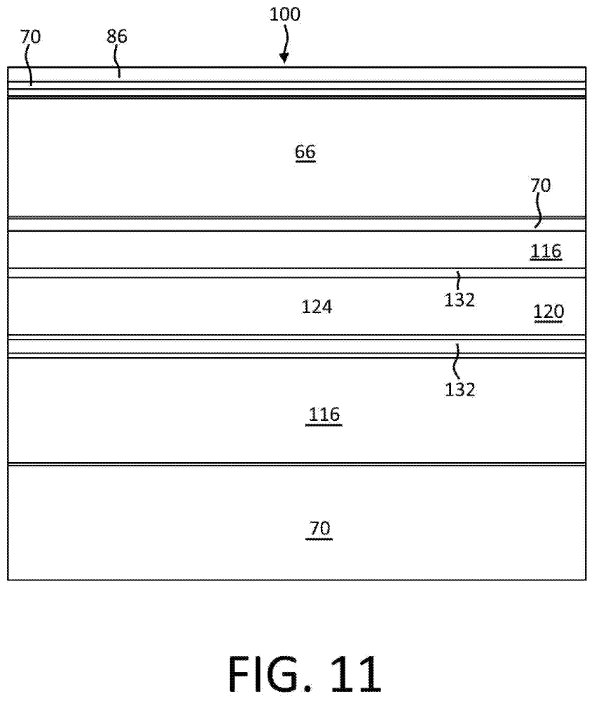

The lateral walls 70 may further comprise series of optional engaging teeth 78 to further engage the composite panel 54 exterior surface to further increase the mechanical connection and/or friction between the components. Understandably, any other means or mechanism increasing the mechanical connection and/or friction between the components may be used. Fasteners 82, in the present situation embodied as screws, are inserted through the connector 50 lateral walls 70 to engage the composite panel 54 inserted in the panel receiving cavity 66. The fasteners 82 are axially aligned toward to the series of engaging teeth 78 for increasing the connection strength with the panels 54.1, 54.2. A plurality of ridges 86 are provided on the exterior surface of the second connector 100 for added mechanical strength while an axial groove 90 is provided to guide the fasteners 82 locations on the second connector 100. The inner surface of the lateral walls 70 may comprise a plurality of cavity ridges 94. The cavity ridges 94 may be located inside the first and second cavities 66 to help secure and assure a tighter fit of the received panels 54.1, 54.2. FIG. 8 throughout FIG. 11 are showing various other alternative view of the second connector 100 for a better understanding of its design and features.

The second connector 100 may further include an inclined portion 104 for housing therein electrical wires or an electrical harness 108 therein and securing thereon other elements, like lights 112, and other possible elements like hooks (not illustrated). The inclined portion 104 includes a wall member 116 that is embodied with a slot 120 in between two portions thereof to give access in a cavity 124 enclosed by an optional cover portion 128. The cover portion 128 is removably secured on the wall member 116 and can be removed to allow access in the cavity 124 and be put back in place to secure the harness 108 therein, or other elements, and for closing the inclined portion 104 for aesthetic reasons.

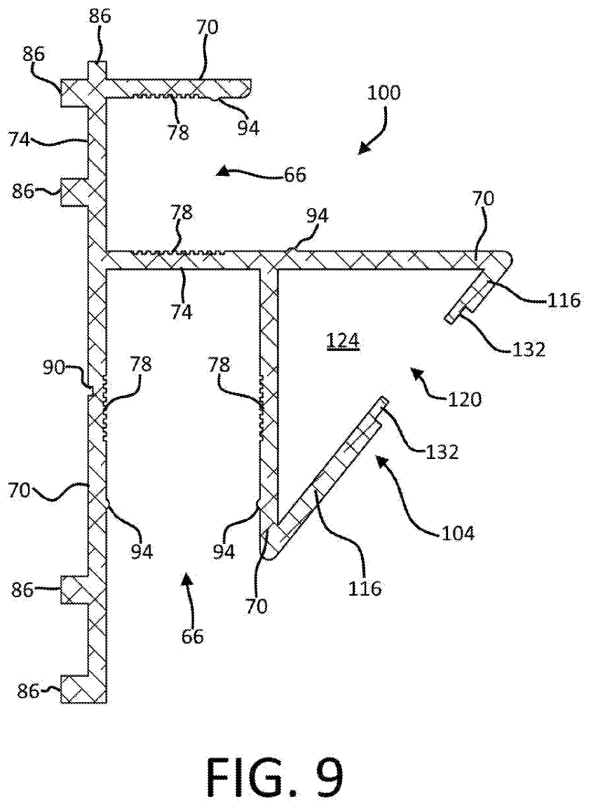

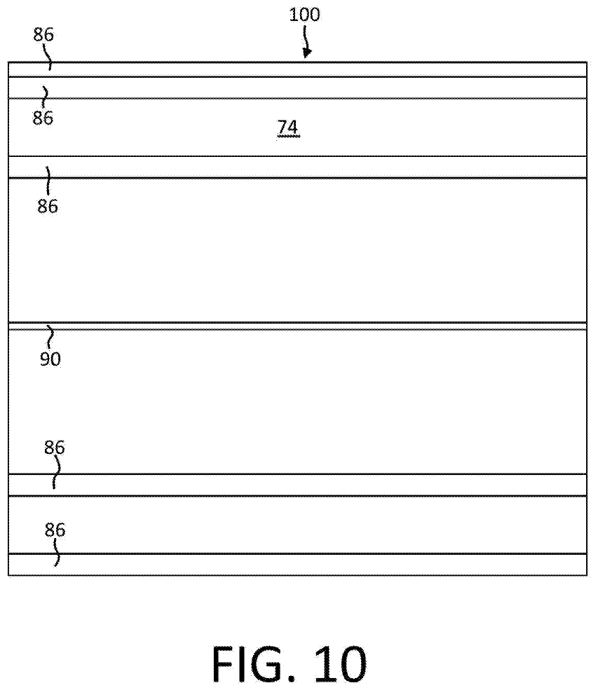

Referring to FIG. 8 to FIG. 11, the second connector 100 is showed in various other alternative views for a better understanding of its design and features. One can appreciate better from FIG. 8 and FIG. 9 that the wall member 116 includes a notch 132 to secure the cover portion 128 and allow a smooth and even outside surface, among other possible uses.

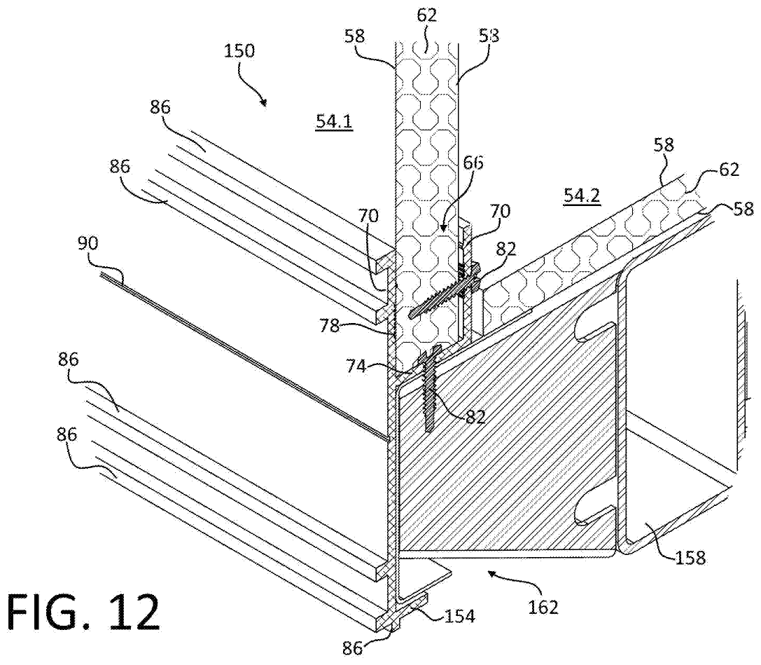

Referring now to FIG. 12, an embodiment of a third connector 150 is illustrated. The second connector 150 generally interconnects two composite panels 54.1 and 54.2. The first composite panel 54.1 is engaged in a panel receiving cavity 66 sized and designed to allow insertion of the panel 54.1 therein while ensuring a proper fit to prevent any relative movements between the parts. Each of the composite panels 54.1, 54.2 includes external wall portions 58 assembled to a core portion 62 in between to give significant mechanical strength while being rather light and inexpensive. The panel-receiving cavity 66 is about 90-degree angle thereof with the second panel 54.2 in the illustrated embodiment although other angles are contemplated by the present invention. One can appreciate that the panel-receiving cavity 66 includes a pair of lateral walls 70 and a bottom wall 74.

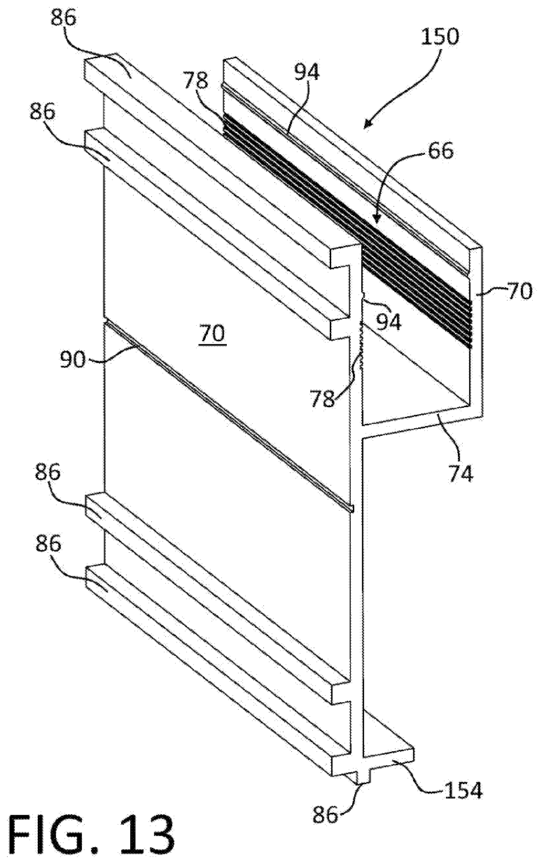

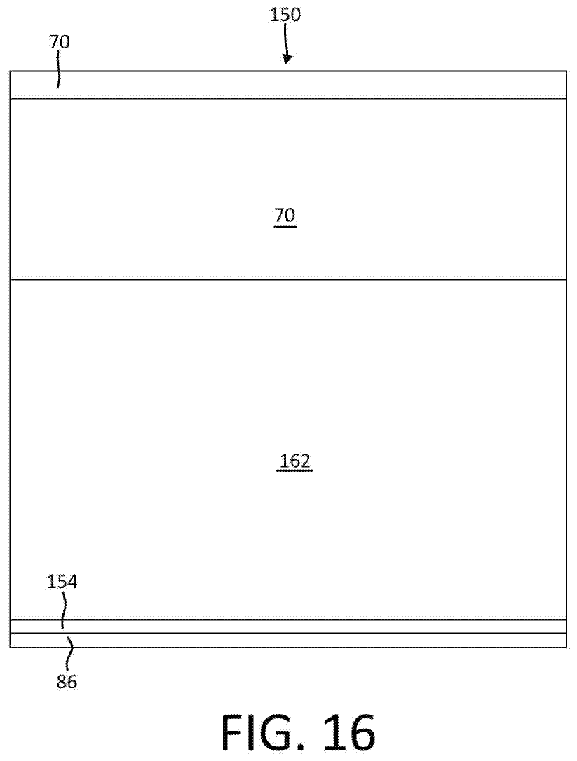

The lateral walls 70 may further comprise series of optional engaging teeth 78 to further engage the composite panel 54 exterior surface and/or to further increase the mechanical connection and/or friction between the components. Understandably, any other means or mechanism increasing the mechanical connection and/or friction between the components Fasteners 82, in the present situation embodied as screws, are inserted through the connector 150 lateral walls 70 to engage the composite panel 54 inserted in the panel-receiving cavity 66. The fasteners 82 are axially aligned toward to the series of engaging teeth 78 for increasing the connection strength with the panel 54.1. A plurality of ridges 86 are provided on the exterior surface of the third connector 150 for added mechanical strength while an axial groove 90 is provided to guide the fasteners 82 locations on the third connector 150. The inner surface of the lateral walls 70 may comprise a plurality of cavity ridges 94. The cavity ridges 94 may be located inside the first and second cavities 66 to help secure and assure a tighter fit of the received panels 54.1, 54.2. The third connector 150 further includes a bottom member 154 parallel with the bottom wall 74 for receiving and securing therebetween a frame component 158 in a frame-receiving cavity 162. FIG. 13 throughout FIG. 16 are showing various other alternative views of the third connector 150 for a better understanding of its design and features.

All the connectors 50, 100, 150, could be manufactured with aluminum extrusions or sheet metal work in steel or other suitable materials. Alternatively, the connectors 50, 100, 150 could be molded in plastic, charged with fibers or not, without departing from the scope of the present description. The composite panels 54 may have a thickness of about 24.5 millimeters (1″) and the corresponding panel-receiving cavities 66 may have a play of about 1.5 millimeter ( 1/16″) to slide fit and be compressed in the panel-receiving cavities 66 secured therein.

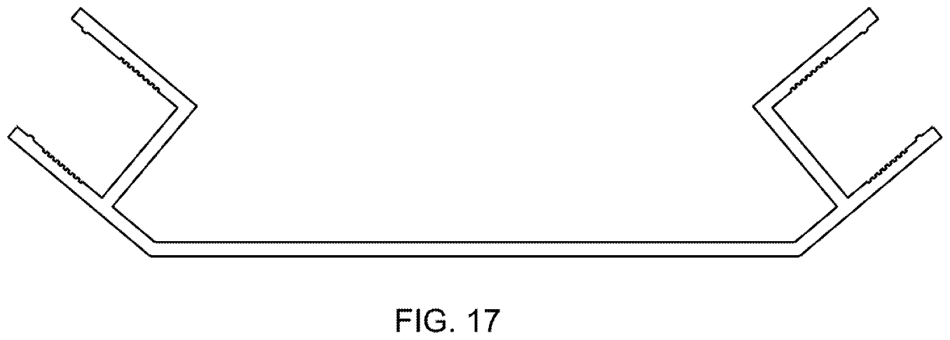

Referring now to FIG. 17, an embodiment of a connector for trailer walls having two cavities at an angle is shown. The connector comprises a main wall having a first end at an angle and a second end at a second angle. Each end comprises walls forming a cavity for receiving a wall of a trailer.

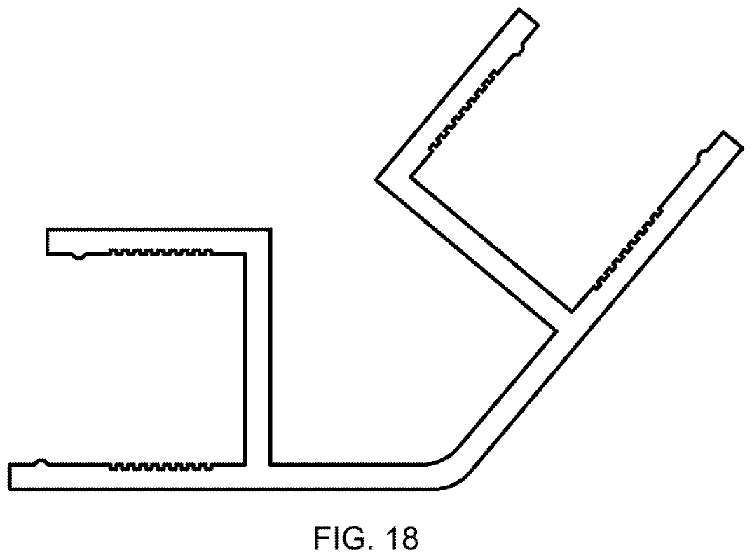

Referring now to FIG. 18, an embodiment of a connector for trailer walls having two cavities at an angle is shown. The connector comprises an angled main wall having a first end and a second end. Each end comprises walls forming distinct cavities for receiving a wall of a trailer at an angle.

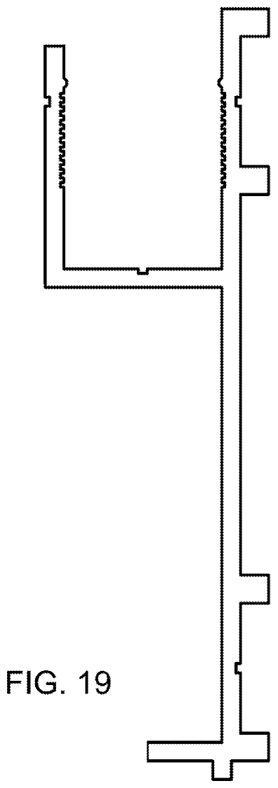

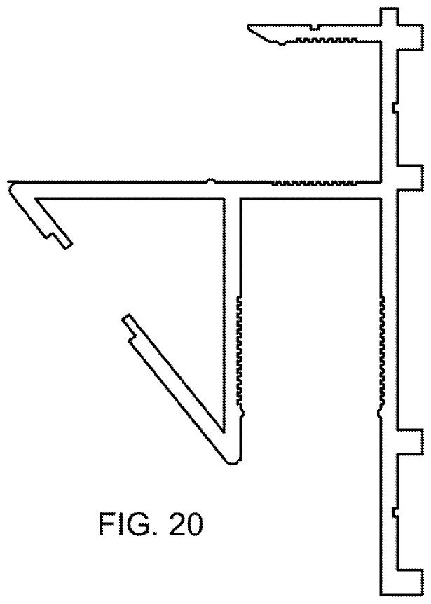

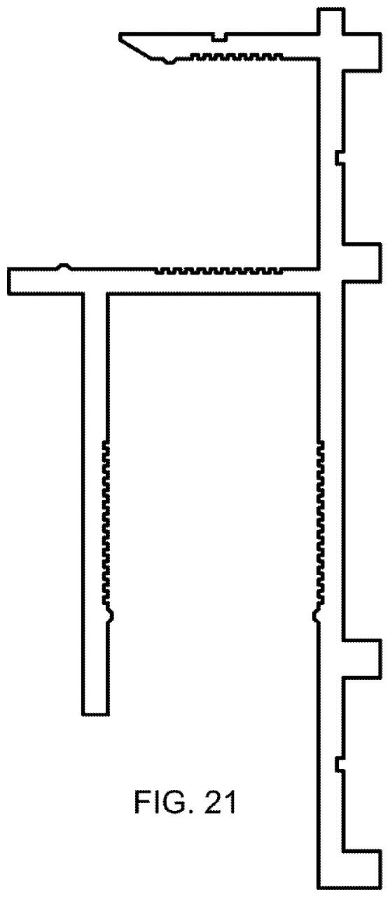

Referring now to FIGS. 19 to 21, different embodiments of the connectors for trailer walls are shown. The connectors comprise groove disposed at different location and adapted to receive a fastener. In some embodiments, such as FIG. 19, the groove is located within cavities of the connector. In some other embodiments, the grooves are located on outer or outside portions of the connector to receive fasteners.

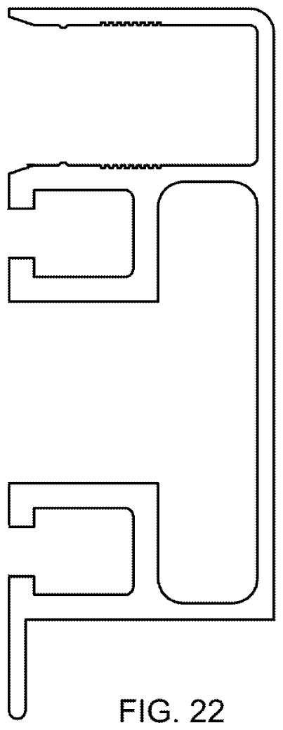

Referring now to FIG. 22, another embodiment of a connector for trailer walls having four cavities is shown. In such an embodiment, the connector comprises a first cavity having friction surfaces. The connector further comprises a central cavity surrounded by side cavities. In some embodiments, as shown in FIG. 22, the central cavity may have a wider lower portion for receiving the wall or for receiving different elements such as cables. The side cavities may also be adapted to receive elements such as cables.

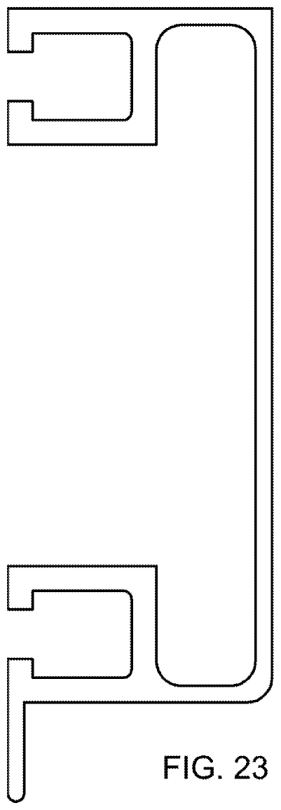

Referring now to FIG. 23, a further embodiment of a connector for trailer walls having two side cavities and a central cavity is shown. In some embodiments, as shown in FIG. 23, the central cavity may have a wider lower portion for receiving the wall or for receiving different elements such as cables. The side cavities may also be adapted to receive elements such as cables. The side cavities are typically positioned to surround the upper portion of the central cavity.

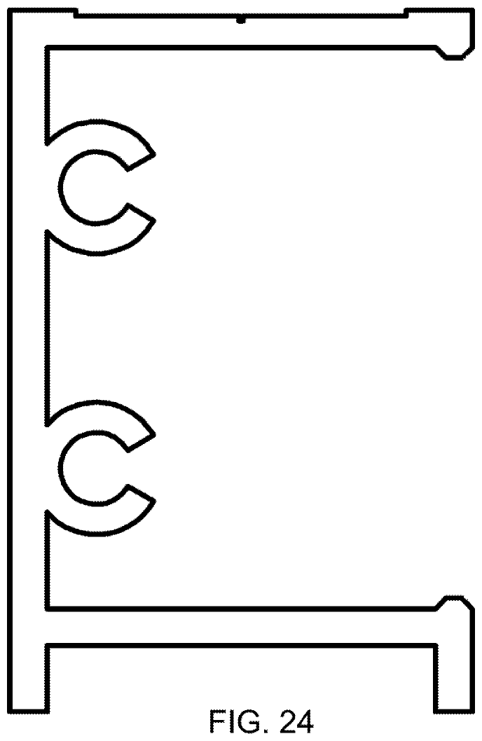

Referring now to FIG. 24, a further embodiment of a connector for trailer walls having a central cavity, a secondary cavity and clipping members is shown. In such an embodiment, the bottom portion of the central cavity comprises rounded members. The rounded members may be adapted to clip or attach to a wall or may be adapted to receive or clip elements such as cables. Understandably, such rounded members may have different shapes or may be otherwise shaped to receive different elements or to allow attaching to different fastening members of the wall to be received.

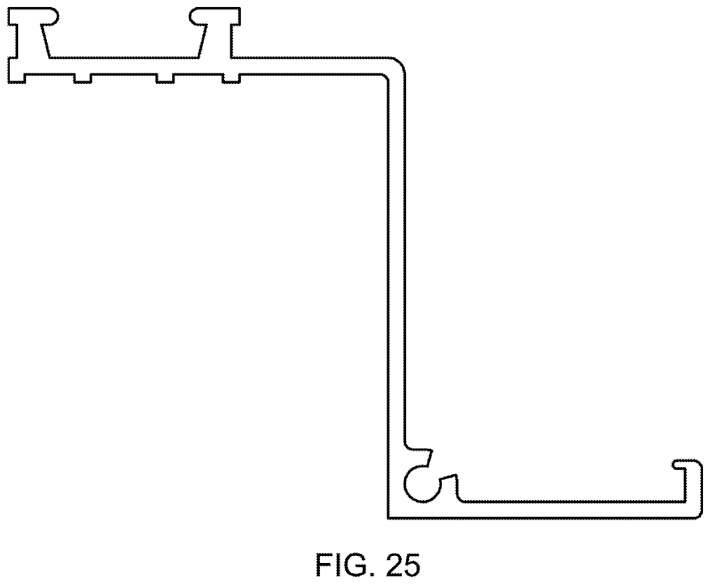

Referring now to FIG. 25, a connector for trailer walls having a L-shape is shown. The L-shape connector comprises a lower cavity and an upper cavity for receiving a wall portion of a trailer. In some embodiments, the upper or lower cavity may comprise a rounded or otherwise shaped portion, typically positioned at the lower portion of a sidewall of a cavity. The upper cavity may further comprise notches or protrusions to connect or to fit into slots or other type of connections of the walls (not shown).

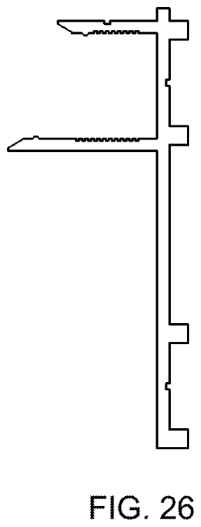

Referring now to FIG. 26, a connector for trailer walls having a main cavity and a flat portion. The connector may comprise a cavity for receiving a wall, the external sidewall of the main cavity being adapted to receive another wall in the flat portion. In some embodiments, the external wall may comprise grooves for receiving fasteners.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A connector for securing at least two panels of a trailer at an angle, the connector comprising:
a main wall and a first lateral wall;
a second lateral wall and a third lateral wall disposed at the angle in relation to the first and second lateral walls;
a first cavity formed by a section of the main wall, the first lateral wall and a section of the second lateral wall; and
a second cavity formed by the third lateral wall, a section of the second lateral wall and a section of the main wall, each cavity being configured to receive a portion of a panel.

2) The connector of claim 1, the main wall comprising a plurality of ridges.

3) The connector of claim 1, at least one of the main, first lateral, second lateral or third lateral wall having a friction surface.

4) The connector of claim 3, the friction surfaces of parallel walls facing one another.

5) The connector of claim 3, the friction surface comprising engaging teeth.

6) The connector of claim 1, an outer surface of the main wall comprising cavity ridges.

7) The connector of claim 1, the first lateral wall and the second lateral wall forming a third cavity.

8) The connector of claim 8, the third cavity being further formed by an inclined wall connected to the first and the second lateral walls.

9) The connector of claim 8, the third cavity being adapted to receive cables.

10) The connector of claim 9, the inclined wall comprising an opening.

11) The connector of claim 10, the connector further comprising a detachable cover to close the opening.

12) The connector of claim 1, each cavity having a width of 1 inch.

13) The connector of claim 1, each cavity having a width of 1/16 inch over the thickness of the panels to be received by each cavity.

14) A connector for securing at least two panels, the connector comprising:
a main wall and a first lateral wall;
a second lateral wall and a third lateral wall disposed at an angle in relation to the main and first lateral walls;
a first cavity formed by a section of the main wall, a section of the first lateral wall and of the second lateral wall;
a second cavity formed by the third lateral wall, a section of the second lateral wall and a section of the main wall, each cavity being configured to receive a portion of a panel; and
cavity ridges located on the surface of the walls comprised in the first and second cavities;
wherein
the main wall comprises a plurality of ridges;
at least one of the main, first lateral, second lateral or third lateral wall comprises a friction surface;
the friction surfaces of two parallel walls face each other's; and
the friction surfaces comprise engaging teeth.

15) The connector of claim 14, the connector further comprising:
a third cavity formed by the first and the second lateral walls;
an inclined wall connected to the first and the second lateral walls further forming the third cavity;
an opening located on the inclined wall; and
a detachable cover to close the opening.

16) A method for connecting panels of a trailer at an angle, the method comprising:
inserting a first panel into a first rigid cavity;
inserting a second panel into a second rigid cavity, the second rigid cavity being at an angle of the first rigid cavity;
securing the first panel to the first cavity;
securing the second panel to the second cavity.

17) The method of claim 16, the method further comprising frictionally holding the first and second panels in the first and second cavities respectively.

18) The method of claim 16, the method further comprising inserting cables in a third cavity connected to the first and second cavities.
